(19) United States
(12) Patent Application Publication
(10) Pub. No.: US 2024/0210679 A1
(43) Pub. Date: Jun. 27, 2024

(54) MIRROR FOR A HEAD-UP DISPLAY

(71) Applicant: Continental Automotive Technologies GmbH, Hannover (DE)

(72) Inventor: Alexander Wolf, Hainburg (DE)

(73) Assignee: Continental Automotive Technologies GmbH, Hannover (DE)

(21) Appl. No.: 18/287,545

(22) PCT Filed: Apr. 5, 2022
(86) PCT No.: PCT/DE2022/200063

§ 371 Date: Oct. 19, 2023

(30) Foreign Application Priority Data
Apr. 20, 2021 (DE) 10 2021 203 930.8

(51) Int. Cl. G02B 27/01; B29C 45/56; B29D 11/00; B29L 11/00; G02B 7/182

(52) U.S. Cl. CPC G02B 27/0101; B29C 45/561; B29D 11/00596; G02B 7/182; G02B 27/0149; B29L 2011/0058

(57) ABSTRACT

A mirror for a head-up display, in particular for a head-up display for transportation is disclosed. A head-up display comprising such a mirror is also disclosed. The mirror has a base body with a planar region and a rib arranged at a periphery of the planar region. A mirror layer is arranged on the planar region wherein the rib has an anti-reflective structure.

### CROSS REFERENCE TO RELATED APPLICATIONS

This U.S. patent application claims the benefit of PCT patent application No. PCT/DE2022/200063, filed Apr. 5, 2022, which claims the benefit of German patent application No. 10 2021 203 930.8, filed Apr. 20, 2021, both of which are hereby incorporated by reference.

### TECHNICAL FIELD

The present disclosure relates to a mirror for a head-up display, in particular for a head-up display for transportation. The disclosure also relates to a head-up display having such a mirror.

### BACKGROUND

A head-up display, also referred to as a HUD, is understood to mean a display system in which the viewer may maintain their viewing direction since the contents to be represented are superimposed on their visual field. While such systems were originally used primarily in the aviation sector due to their complexity and costs, they are now also being used in large-scale production in the automotive sector.

Head-up displays generally comprise a picture generating unit (PGU), an optical unit, and a mirror unit. The picture generating unit generates the image and for this purpose uses at least one display element. The optical unit directs the image onto the mirror unit. The mirror unit is a partially reflecting, light-transmissive pane. The viewer thus sees the contents represented by the picture generating unit as a virtual image and sees the real world behind the pane at the same time. In the automotive sector, the windshield is often used as mirror unit, and its curved shape must be taken into account in the representation. Due to the interaction between the optical unit and the mirror unit, the virtual image is an enlarged representation of the image produced by the picture generating unit.

The optical unit typically comprises a plurality of mirrors to keep the required installation space as small as possible. The light emerging from the picture generating unit is reflected by a folding mirror onto a curved mirror, which then reflects it toward the windscreen. The currently used curved mirrors are designed in the form of substantially flat plates with a large curvature corresponding to the desired optical function. Such curved mirrors are produced, for example, by injection molding or injection compression molding.

In this context, DE 10 2010 043 947 A1 describes a method for producing a mirror, in which at least one base body is coated with at least one light-reflecting coating material. In the method, the coating material is applied to a surface of an injection mold and then the base body is placed onto the coating material. The base body is formed in this case from an injection-moldable material, which is injected into a cavity of the injection mold.

WO 2016/189361 A1 describes a mirror for a head-up display. The mirror is an injection molded part with a back and a front. Integrated into the back are pivot bearings and holders for a motor or a spring. The front has a mirror coating.

However, the flexural rigidity of the components thus produced is low. The lack of flexural rigidity is therefore compensated by way of the material thickness. This results in extended cycle times and high material costs. In addition, the components are filled via a wide sprue, which must then be milled off. This requires an additional work step.

It is the object of the present disclosure to provide an improved mirror for a head-up display.

### SUMMARY

According to a first aspect of the disclosure, a mirror for a head-up display has a base body having a planar region and a rib arranged at a periphery of the planar region. A mirror layer is arranged on the planar region.

With the solution according to the disclosure, the mirror is not designed as a substantially flat plate as in the prior art, but has a rib at least at some of its periphery. For example, in a rectangular mirror, a rib may be formed on each of the long sides. This structure causes an increased flexural rigidity, so that the mirror becomes much less sensitive to mechanical influences. This allows the material thickness to be reduced and thus also the material costs and the required cycle time.

According to one aspect of the disclosure, the rib is designed as a circumferential rib. In this case, the mirror is designed like a pan or trough, resulting in a particularly high flexural rigidity.

According to one aspect of the disclosure, the rib is inclined relative to a mirror axis of the mirror. The mirror axis refers to the normal on the mirror layer in the center of the mirror layer. This allows microstructures to be introduced into the rib, which extend up to the lower edge of the mirror layer. For example, the inclination of the rib relative to the mirror axis may be in the order of 15°.

According to one aspect of the disclosure, the rib has an anti-reflective structure. There is a risk of light reflection on the side surfaces of the mirror. This may be avoided by an anti-reflective structure. For example, a microstructure may be introduced into the rib as an anti-reflective structure.

According to one aspect of the disclosure, the anti-reflective structure is manufactured by laser structuring or sandblasting. For a sufficiently large inclination of the rib relative to the mirror axis, there is the possibility of introducing into the rib by laser structuring a microstructure which extends to the lower edge of the mirror layer. Alternatively, sandblasting or similar technologies may be used to introduce into the rib a microstructure that has a smaller depth. In this case, the angle of the rib relative to the mirror axis may be reduced.

According to one aspect of the disclosure, the mirror layer is formed by a coating applied to the base body or by a mirror element placed onto the base body. The application of a coating to the base body has the advantage that no separate mirror element needs to be produced and handled. The placement of a mirror element, by contrast, has the advantage that the requirements relating to the surface quality of the base body are reduced. Preferably, the mirror layer is arranged on the side of the base body facing away from the rib. This simplifies the production of the mirror layer. In principle, however, it may also be arranged on the side of the base body facing the rib.

According to one aspect of the disclosure, a thickness of the planar region or rib is less than 3.5 mm. By reducing the thickness to this value, the material thickness is reduced by an order of magnitude of approx. 30% compared with conventional mirrors. Optimal values may be ascertained, for example, by simulations using finite elements.

According to one aspect of the disclosure, the base body is manufactured by injection molding or injection compression molding with a hot runner film gate. The use of a film gate in conjunction with hot runner technology has the advantage that there is no need to separate the base body by milling after the injection molding or injection compression molding procedure. This prevents the formation of chips and eliminates the risk of stress cracks. Overall, this approach reduces waste in production. When producing the base body by injection compression molding, the material thickness may be adjusted by varying the compression ram. If the mirror layer is arranged on the side of the base body facing away from the rib, the compression ram may be produced cost-effectively, since it does not require on its surface the precision or polish of the mirror.

According to one aspect of the disclosure, a compression core used in injection molding in the region of a transition between the planar region and the rib has a geometry which is designed to compensate for a shape deviation due to volume loss during cooling of the base body. Due to the relatively large amount of material at the transition from the rib to the planar region and the associated corresponding volume shrinkage during cooling, there is a risk of a small shape deviation in this region. This shape deviation may be reduced or entirely prevented by a counteracting adaptation of the geometry of the compression ram. The required preliminary deformation of the compression ram may be ascertained, for example, by simulations or tests.

Preferably, a mirror according to the disclosure is used in a head-up display for transportation, e.g., in a head-up display for a motor vehicle. Due to its structure, the mirror according to the disclosure is relatively insensitive to mechanical influences, such as vibrations or shocks caused by potholes, etc. Accordingly, a head-up display with a mirror according to the disclosure is preferably used in transportation.

### BRIEF DESCRIPTION OF THE DRAWINGS

Further features of the present disclosure will be evident from the following description and the appended claims in conjunction with the figures, wherein:

FIG. 1 schematically shows a head-up display according to the prior art for a motor vehicle;

FIG. 2 schematically shows a mirror according to the prior art for a head-up display;

FIG. 3 schematically shows a mirror according to the disclosure for a head-up display;

FIG. 4 illustrates the production of a mirror according to the disclosure by injection compression molding;

FIG. 5 schematically shows a pre-deformation of a compression ram for compensating shape changes; and

FIG. 6 schematically shows an anti-reflective structure introduced into a rib of the mirror.

### DETAILED DESCRIPTION

For a better understanding of the principles of the present disclosure, embodiments of the disclosure will be explained in more detail below with the aid of the figures. The same references are used in the figures for identical or functionally identical elements and are not necessarily described again for each figure. It is understood that the disclosure is not limited to the illustrated embodiments and that the described features may also be combined or modified without departing from the scope of protection of the disclosure as defined in the appended claims.

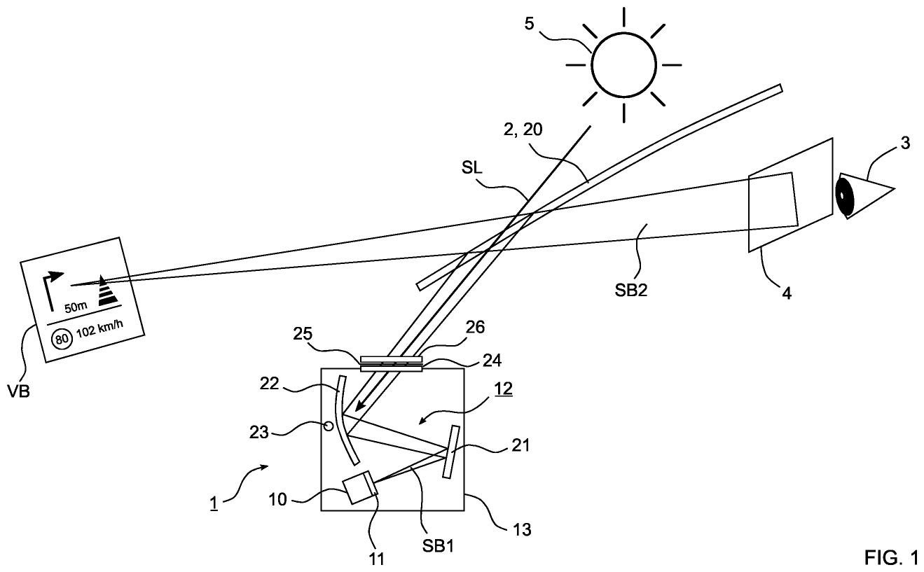

FIG. 1 shows a schematic diagram of a conventional head-up display for a motor vehicle. The head-up display has a display apparatus 1 with a picture generating unit 10 and an optical unit 12. A beam SB1 emanates from a display element 11 and is reflected by a folding mirror 21 onto a curved mirror 22 that reflects it in the direction of a mirror unit 2. The mirror unit 2 is illustrated here as a windshield 20 of the motor vehicle. From there, the beam SB2 travels in the direction of an eye of a viewer 3.

The viewer 3 sees a virtual image VB that is located outside the motor vehicle, above the engine hood or even in front of the motor vehicle. Due to the interaction between the optical unit 12 and the mirror unit 2, the virtual image VB is an enlarged representation of the image displayed by the display element 11. A speed limit, the current vehicle speed and navigation instructions are symbolically represented here. As long as the eye of the viewer 3 is located within an eyebox 4, indicated by a rectangle, all elements of the virtual image VB are visible to the user 3. If the eye of the viewer 3 is located outside of the eyebox 4, the virtual image VB is only partially visible to the user 3 or not at all. The larger the eyebox 4 is, the less restricted the viewer is when choosing their seating position.

The curvature of the curved mirror 22 is adapted to the curvature of the windshield 20 and ensures that the image distortion is stable over the entire eyebox 4. The curved mirror 22 is rotatably mounted by a bearing 23. The rotation of the curved mirror 22 that this allows makes it possible to shift the eyebox 4 and thus to adapt the position of the eyebox 4 to the position of the viewer 3. The folding mirror 21 serves to ensure that the path traveled by the beam SB1 between the display element 11 and the curved mirror 22 is long and, at the same time, that the optical unit 12 is nevertheless compact. The picture generating unit 10 and the optical unit 12 are separated from the environment by a housing 13 having a transparent cover plate 24. The optical elements of the optical unit 12 are thus protected, for example against dust inside the vehicle. An optical film or a polarizer 25 may furthermore be located on the cover plate 24. The display element 11 is typically polarized, and the mirror unit 2 acts like an analyzer. The purpose of the polarizer 25 is therefore to influence the polarization in order to achieve uniform visibility of the useful light. A cover arrangement 26 arranged on the cover plate 24 serves to reliably absorb the light reflected via the interface of the cover plate 24 so that the viewer is not dazzled. In addition to sunlight SL, the light from another stray light source 5 may also reach the display element 11. In combination with a polarization filter, the polarizer 25 may additionally also be used to reduce incident sunlight SL.

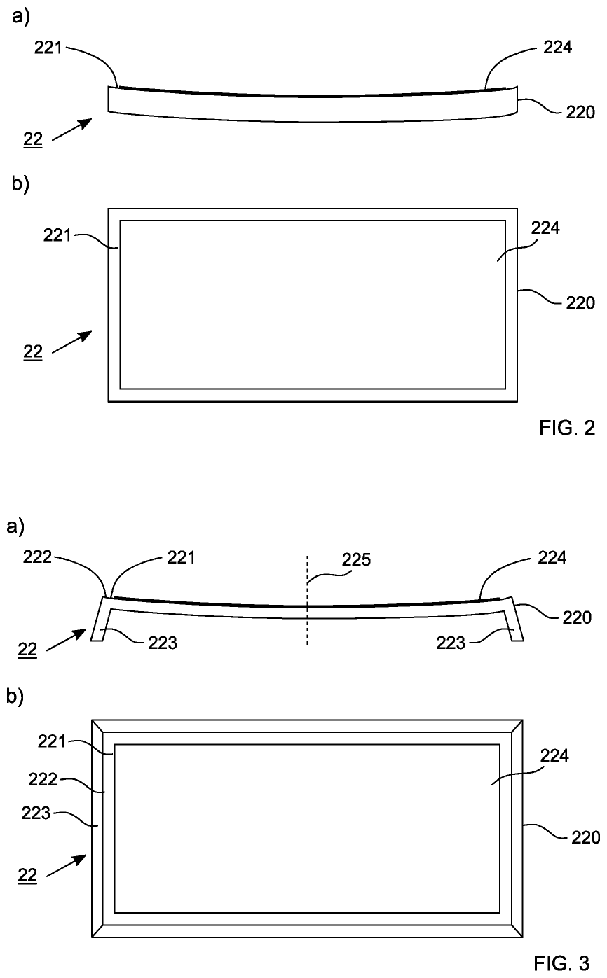

FIG. 2 schematically shows a mirror 22 according to the prior art for a head-up display. FIG. 2a) shows a side view, and FIG. 2b) shows a top view. The mirror 22 has a base body 220, which comprises merely a planar region 221. A mirror layer 224 is arranged on the planar region 221. The mirror 22 is thus designed in the form of a substantially flat plate having a large curvature corresponding to the desired optical function. For example, the mirror 22 may be produced by injection molding or injection compression molding a transparent thermoplastic, e.g., COC (cyclic olefin copolymer). To ensure sufficient flexural rigidity, currently used mirrors 22 have a thickness of greater than or equal to 5 mm. This results in extended cycle times and high material costs. In addition, the components are filled via a wide sprue, which must then be milled off. This requires an additional work step.

FIG. 3 schematically shows a mirror 22 according to the disclosure for a head-up display. FIG. 3a) shows a side view, and FIG. 3b) shows a top view. The mirror 23 has a base body 220, which has a rib 223 in addition to a planar region 221. The rib 223 is arranged at a periphery 222 of the planar region 221. In the example shown, the rib 223 is designed to extend around the planar region 221, i.e., the base body 220 is designed like a pan or a trough. However, it is likewise possible that the base body 220 has a rib 223 only at some of its periphery. For example, in a rectangular mirror 22, a rib 223 may be formed only on each of the long sides. This rib 223 causes an increased flexural rigidity, so that the mirror 22 becomes much less sensitive to mechanical influences. This allows the material thickness to be reduced and thus also the material costs and the required cycle time. Preferably, the thickness of the planar region 221 is less than or equal to 3.5 mm. The rib 223 can also be made with this thickness.

On the base body 220, a mirror layer 224 is again arranged. The latter may be formed by a coating applied to the base body 220 or by a mirror element that has been placed onto the base body 220. In FIG. 3, the mirror layer is arranged on the side of the base body 220 facing away from the rib 223. In principle, however, it may also be arranged on the side of the base body 220 facing the rib 223. In the embodiment in FIG. 3, the rib 223 is inclined relative to a mirror axis 225 of the mirror 22. The mirror axis 225 refers to the normal on the mirror layer 224 in the center of the mirror layer 224. This allows microstructures to be introduced into the rib 223, which extend up to the lower edge of the mirror layer 224. The inclination of the rib 223 relative to the mirror axis 225 may be in the order of 15°, for example.

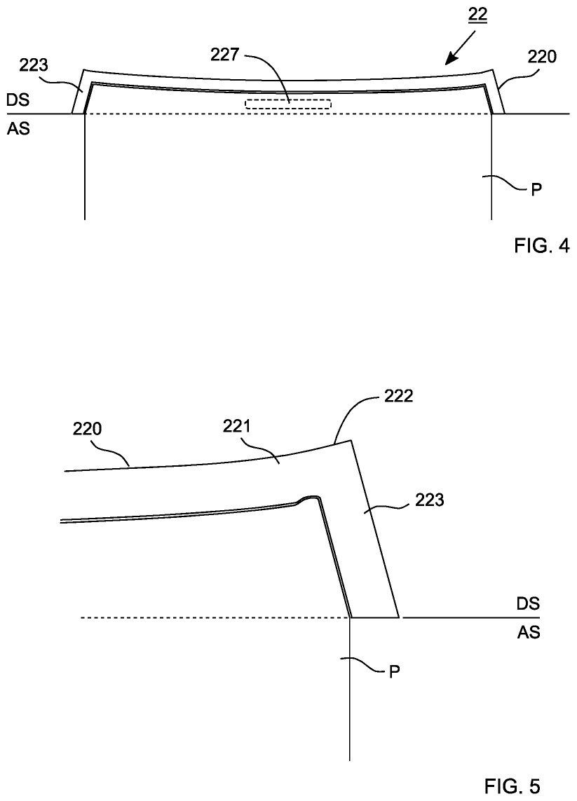

FIG. 4 illustrates the production of a mirror 22 according to the disclosure by injection compression molding. It shows a section through the nozzle side DS and the ejector side AS of an injection compression molding tool. A compression ram P is used to shape the base body 220. The material thickness of the base body 220 may be adjusted by a variation of the compression ram P. Preferably, a hot runner film gate is used in the production of the base body 220. The film gate 227 is indicated in FIG. 4 laterally at the rib 223. The use of a film gate 227 in conjunction with hot runner technology has the advantage that there is no need to separate the base body 220 by milling after the injection molding or injection compression molding procedure. This prevents the formation of chips and eliminates the risk of stress cracks. Overall, this approach reduces waste in production. If the mirror layer is arranged on the side of the base body facing away from the rib, the compression ram P may be produced cost-effectively, since it does not require on its surface the precision or polish of the mirror.

FIG. 5 schematically shows a pre-deformation of a compression ram P for compensating shape changes. An enlarged section of the transition from the rib 223 to the planar region 221 is shown. Due to the relatively large amount of material at this point and the associated corresponding volume shrinkage during cooling, there is a risk of a small shape deviation in this region. This shape deviation may be reduced or entirely prevented by a counteracting adaptation of the geometry of the compression ram P. The required pre-deformation of the compression ram P may be ascertained, for example, by simulations or tests.

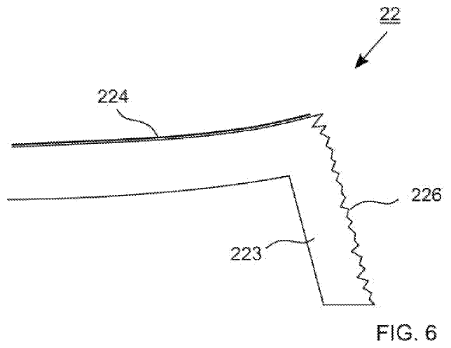

FIG. 6 schematically shows an anti-reflective structure 226 introduced into a rib 223 of the mirror 22. There is a risk of light reflection on the side surfaces of the mirror 22. This may be avoided by an anti-reflective structure 226. For example, a microstructure may be introduced into the rib 223 as an anti-reflective structure 226. For a sufficiently large inclination of the rib 223 relative to the mirror axis, there is the possibility of introducing into the rib 223 by laser structuring a microstructure which extends up to the lower edge of the mirror layer 224. Alternatively, sandblasting or similar technologies may be used to introduce into the rib 223 a microstructure that has a smaller depth. In this case, the angle of the rib 223 relative to the mirror axis may be reduced.

1. A mirror for a head-up display, comprising:
a base body with a planar region and a rib arranged at a periphery of the planar region; and
a mirror layer arranged on the planar region, wherein the rib has an anti-reflective structure.

2. The mirror as claimed in claim 1, wherein the rib is designed as a circumferential rib.

3. The mirror as claimed in claim 1, wherein the rib is inclined relative to a mirror axis of the mirror.

4. The mirror as claimed in claim 1, wherein the anti-reflective structure is manufactured by laser structuring or sandblasting.

5. The mirror as claimed in claim 1, wherein the mirror layer is formed by a coating applied to the base body r by a mirror element placed onto the base body.

6. The mirror as claimed in claim 1, wherein a thickness of the planar region or of the rib is less than 3.5 mm.

7. The mirror as claimed in claim 1, wherein the base body is manufactured by means of injection molding or injection compression molding with a hot runner film gate.

8. The mirror as claimed in claim 7, wherein a compression ram used in injection molding has in the region of a transition between the planar region and the rib a geometry which is designed to compensate for a shape deviation due to volume loss during cooling of the base body.

9. A head-up display for transportation, comprising a mirror comprising:
a base body with a planar region and a rib arranged at a periphery of the planar region; and
a mirror layer arranged on the planar region, wherein the rib has an anti-reflective structure.
